(19) United States
(12) Patent Application Publication
(10) Pub. No.: US 2009/0304883 A1
(43) Pub. Date: Dec. 10, 2009

(54) METHOD FOR PREPARING HYPOALLERGENIC DERIVATIVES OF FRUIT AND/OR VEGETABLE PIECES

(76) Inventors: Carlo Pompei, Cassina De'pecchi (IT); Oreste V. Brenna, Milano (IT); Laura Primavesi, Milano (IT)

Correspondence Address: DICKSTEIN SHAPIRO LLP, 1825 EYE STREET NW, Washington, DC, 20006-5403, US

(21) Appl. No.: 12/282,100

(22) PCT Filed: Mar. 9, 2007
(86) PCT No.: PCT/IT07/00174

§ 371 Date: Apr. 6, 2009

(30) Foreign Application Priority Data
Mar. 9, 2006 (IT) MI2006A000424

(51) Int. Cl. A23L 1/015; A23L 1/212; A23L 1/00

(52) U.S. Cl. 426/287; 426/442; 426/615; 426/640; 426/634

(57) ABSTRACT

The object of the present invention is a novel fruit and vegetable transformation process for the production of hypoallergenic industrial derivatives in pieces (cubes, slices, segments etc.), intended mainly for individuals with OAS (Oral Allergy Syndrome) following the consumption of fresh products and/or the traditional industrial derivatives thereof, but also for general consumption in order to prevent sensitisation in atopic patients. In a second aspect, the present invention also relates to products that can be obtained by means of said process.

### FIELD OF THE INVENTION

The object of the present invention is a novel fruit and vegetable transformation process for the production of hypoallergenic products in pieces (cubes, slices, segments etc.), mainly intended for individuals with OAS (Oral Allergy Syndrome) following the consumption of fresh products and/or traditional industrial derivatives thereof, but also for general consumption in order to prevent sensitisation in atopic patients.

### STATE OF THE ART

Allergy to food represents a clinically unresolved problem among the most common disorders affecting industrialised populations. It is estimated that approx. 8% of children and 2% of adults suffer from food allergies. In the west, the major food allergens are found in eggs, milk, fish, peanuts, soya, nuts, fruit and vegetables.

A study based on data collected over a four year period in the USA, has lead to an extrapolated incidence of 29,000 cases of food-related anaphylaxis, with approx. 150 deaths annually. This value, if correlated to the population of the EU, would indicate a likelihood of approx. 200 deaths annually due to food-related anaphylactic shock.

It has been shown that, over recent years, an increasing number of individuals suffer from this disorder. The only remedy currently available, in the case of confirmed allergy, consists of eliminating the reaction-triggering foodstuff from the diet. This is certainly far from an ideal solution since many of the offending foodstuffs represent staple dietary components, and also the offending foodstuff may be present in small quantities, due to voluntary or accidental inclusion in complex foodstuffs.

To date, the scientific and transformation industry sectors have shown little interest in research aimed at the development of hypo- or anallergenic products.

Industrial derivatives of fruit and vegetables, in a wide range of forms, are produced and consumed all over the world.

Some of the industrial derivatives already on the market are already, in part, hypoallergenic, with respect to the fresh product, due to the thermal instability of some of the allergenic proteins present. However, the protein responsible for OAS (oral allergy syndrome), a Lipid Transfer Protein (LTP), is found in industrially processed products due to its high stability at high temperatures.

A previous patent (WO2005/082164 A1) describes technology allowing the attainment of hypoallergenic fluid products from fruit and vegetables, by means of the combination of three technological stages: centrifugation, ultrafiltration and washing with an acid solution. Said innovative technology, which, in summary, envisages the centrifugal separation of pulp from juice, the ultrafiltration of the juice, washing the pulp with an acid solution and the remixing of the ultrafiltration permeate with the washed pulp, can only be applied to fluid products (purees), in order to give products such as tomato paste and concentrate, fruit juices and nectars, jams etc., and, in any case, finished products which do not preserve the original structure of the fruit or vegetable.

The method of the present invention is also aimed at the production of hypoallergenic fruit and vegetable derivatives, but unlike the previous method, and it is in this difference that the originality resides, such derivatives preserve the structure and appearance of the starting product. This characteristic, obtainable by means of a process that differs obviously from the previous, and optimised according to the product, greatly expands the range of derivatives that can be obtained, from natural appertized products (fruit and vegetables) or syrups (fruit), to fresh products that are frozen or in protective atmospheres, to candied products, dried products and, with intermediate levels of humidity, pickled and oil-preserved products, etc. Furthermore, such products can be in various shapes and sizes, such as: cubes, slices, segments, sticks, strings, etc. or whole, if small enough (for example cherries, black-cherries, grapes etc.).

The problem addressed by the present invention is that of producing hypoallergenic products in pieces, derived from fruit and vegetables, particularly with negligible or no LTP present and, hence, suitable for those individuals suffering from OAS as a result of fruit and/or vegetables.

Said problem is resolved by a process as defined in the appended claims.

In a first aspect thereof, the present invention relates to a process for the production of hypoallergenic derivatives of fruit and/or vegetables in pieces comprising, for certain fruit and vegetables, a chemical peeling stage (a), and a stage consisting of immersing the “pieces” for suitable periods of time in an acid solution maintained at a suitable temperature and containing the ingredients (b) which will be defined hereinafter. The finished product is a hypoallergenic derivative of fresh fruit and/or vegetables.

The chemical peeling (a) is preferably carried out by the immersion of the fruit or vegetable in a hot solution of soda (sodium hydroxide), followed by rinsing with water and acidified water.

The acid solution (b) is preferably a solution of citric acid, also containing anti-oxidants, preferably ascorbic acid.

The hypoallergenic product thus obtained can be subjected to freezing, in order to obtain a “fresh” frozen product, or appertizing in order to obtain a preserve, or subjected to drying. Said transformations are achieved according to known technologies.

In a second aspect thereof, the present invention relates to products that can be obtained by means of the above-described process. Said products are hypoallergenic industrial derivatives of fruit and/or vegetables, by way of example, appertized fruit salad in syrup or natural, appertized vegetable salads, appertized natural vegetables, frozen fruit and vegetables, fresh fruit and vegetables in modified atmospheres, pickled vegetables, part dried fruit and vegetables (Intermediate Moisture Foods=IMF), dried vegetable flakes, dried powdered vegetables, etc. Said hypoallergenic products are preferably obtained from: tomato (Lycopersicon esculentum), carrot (Daucus carota), string bean (Faseolus vulgaris), pea (Pisum sativus), celery (Apium graveolens), celeriac (Apium graveolens rapaceum), sweet pepper (Capsicum annuum), cucumber (Cucumis sativa), egg plant (Solanum melongena), squash and courgette (Cucurbita spp.), cabbage (Brassica spp.), fennel (Foeniculum vulgare), peach (Prunus persica), apricot (Prunus armeniaca), maize (Zea mais), apple (Malus communis), pear (Pyrus communis), cherry and black-cherry (Prunus avium and Prunus cerasus), kiwi (Actinidia chinensis, Actinidia deliciosa), melon (Cucumis melo), pineapple (Ananas spp.), banana (Musa spp.), grape (Vitis spp.).

The term “hypoallergenic” is meant to define products which can also be anallergenic. Indeed, the protein content of the final product, obtained by means of the process of the invention, can even be considered to be zero.

Further characteristics and advantages of the process according to the present invention, will be much more evident from the following description.

By means of techniques known to those skilled in the art, the fruit and/or vegetables, after washing and sorting, are subjected to peeling, the majority of which is performed according to the known art (for example: coring for apples and pears, stoning for peaches, apricots and cherries, leaf-stripping for cabbages etc.). Chemical peeling, which is necessary for certain fruit and vegetables, is performed according to a known process.

Whenever necessary, chemical peeling is performed by immersing the fruit or vegetable in a solution of caustic soda having a concentration comprised of between 1 and 20%, more particularly between 3 and 10%, maintained at a temperature comprised of between 10 and 100° C., more particularly between 30 and 85° C. Contact with the caustic soda solution lasts from 30 seconds to 20 minutes, more particularly from 1 to 10 minutes. The caustic soda solution may also contain food grade surfactants known in the sector (for example ethyl linoleate) in order to enhance the wettability of the fruit or vegetable by the solution itself. Alternatively, peeling, if required, can be performed mechanically, as per the known art. Upon completion of this stage, the fruit or vegetables are rinsed under running water and subsequently rinsed with acidified water containing an organic or mineral acid, preferably citric acid, at a concentration comprised of between 0.1 and 3%, preferably from 0.5 to 2.0%.

The fruit or vegetable, after having undergone the above described operations, is subjected to size reduction, which is performed using known techniques and equipment, for the production of fruit halves, cubes, slices, segments, sticks, strings, and other analogous shapes and sizes, to those normally used for such products depending on the intended destination of the same in terms of finished product. In certain cases (for example: cherries, black-cherries, grapes, string beans etc.) size reduction can even be omitted.

The subsequent stage consists in immersing the fruit or vegetables thus prepared in an aqueous acidic solution of organic or mineral acids. More specifically, an acidic citric acid solution will be used. The concentration of acid may be comprised of between 0.1 and 10%, more specifically between 0.5 and 5%. Said solution may contain antioxidant compounds with the aim of protecting the product from oxidation. All the legally permitted products with this capacity can be used. More specifically, ascorbic acid in concentrations comprised of between 0.3 and 1.5 g/L. or sulphurous anhydride, added as metabisulphite, in concentrations comprised of between 0.05 and 0.3 g/L. To the acid solution containing antioxidants may be added calcium chloride, at a concentration comprised of between 0.3 and 2.0 g/L, preferably comprised of between 0.5 and 1.2 g/L. The solution will have a temperature comprised of between 3 and 100° C., more specifically between 5 and 40 ° C. or between 50 and 90° C. The solid (fruit/vegetable) to solution ratio may be comprised of between 0.1 and 1.0, more specifically between 0.4 and 0.8 (p/v). The immersion time of the solid in the solution may be comprised of between 1 minute and 24 hours, more specifically between 2 and 30 minutes, or between 5 and 20 hours. During immersion, the solid may or may not be subjected to gentle shaking. On completion of the immersion time, the solid, once extracted from the solution, may be once more subjected to a washing stage, performed under analogous or similar conditions to the previous wash. Said stages may be more than one in total, preferably two. Alternatively, treatment with the antioxidant containing acid solution can be performed as a continuous process (washing in a countercurrent) for periods of times and at temperatures analogous to those mentioned previously.

After use, the acid solution can be subjected to ultrafiltration using membranes with a suitable cut-off, according to known technologies, and the ulrafiltrate can be reused for the washing stage in a new process. Upon completion of the operation, the solid is extracted from the solution, drained and used for transformation to give various types of product, according to traditional, known technologies. For example, the following types of product may be obtained: appertized fruit in syrup, appertized natural fruit, appertized natural vegetables, candied fruit or vegetables, dried fruit or vegetables, Intermediate Moisture Food (IMF) type products, freshly frozen fruit or vegetables, pickled or sweet pickled vegetables.

The process of the present invention provides hypoallergenic products derived from fruit and/or vegetables. Thereby, those persons suffering from OAS, who have been forced to eliminate such foodstuffs from their daily diet, may use such products, indispensable for a balanced, nutritionally correct and palatable diet. Furthermore, they may be eaten habitually in order to prevent sensitisation in atopic patients.

The examples reported hereinafter are by way of non-comprehensive example of the process.

### EXAMPLE 1

100 kg of healthy, industrially ripened “percoca” peaches (pavie), have been subjected to peeling with caustic soda. The solution contained 10% caustic soda and 0.2% standard food-grade surfactant. The temperature of the caustic soda solution was 60° C. The fruit, held within suitably perforated baskets, have been immersed for 1.5 minutes, after which they have been removed and immersed in a tank containing continuously flowing water at room temperature, and kept shaking. After several minutes, the baskets have been removed and immersed for several minutes in a tank containing a 0.5% solution of citric acid. The peeled peaches have been stoned and cut into cubes using standard machinery used for such purposes. Cubes of nominal side 10 mm have been obtained. The cubes have been placed in suitable baskets which have been immersed in a tank containing a solution of 1.5% citric acid and 0.1% ascorbic acid. The ratio of weight of cubes to volume of solution was equal to 0.5. The solution was maintained at 60° C. and the cubes have been left immersed in the solution for 8 minutes, with gentle agitation. The baskets containing the cubes have been removed from the solution and the procedure repeated, immersing the baskets for 5 minutes in a fresh solution analogous to the previous, again maintained at 60° C. On completion, the cubes have been removed, drained and used for the production of appertized peach cubes in syrup, according to the known art.

### EXAMPLE 2

Just as the previous example, with the difference being that the cubes have been treated for 3 hours in a constantly flowing citric acid and ascorbic acid solution, maintained at room temperature.

### EXAMPLE 3

Just as the previous example, with the difference being that after stoning, the “percoca” peaches have been sliced, to give slices with nominal thickness of 10 mm. The citric acid and ascorbic acid solution was maintained at 70° C. and the immersion time has been 6 minutes. This stage has been repeated with fresh acid solution and under the same conditions, but reducing the immersion time to 4 minutes. The slices thus treated have been sent for drying in a tunnel in tunnel in order to give IMF peach slices.

### EXAMPLE 4

50 kg of healthy, industrially ripened Granny Smith apples have been subjected to peeling using caustic soda. The solution contained 10% caustic soda and was maintained at a temperature of 80° C.. The fruit, held within suitably perforated baskets, have been immersed for 4 minutes, after which they have been removed and immersed in a tank containing continuously flowing water at room temperature, and kept shaking. After several minutes, the baskets have been removed and immersed for several minutes in a tank containing a 0.5% solution of citric acid. Using known equipment, the peeled apples have been cored and cut into wedges. 16 wedges have been obtained from each apple. The wedges have been placed in suitable baskets, which have been immersed in a tank containing a solution of 0.8% citric acid, 0.1% ascorbic acid and 0.8 g/L calcium chloride. The ratio of the weight of wedges to the volume of solution was equal to 0.1. The solution was maintained at 20° C. with gentle stirring, and the wedges have been left immersed for 16 hours. At the end of this time, the wedges have been removed, quickly drained and rinsed in tap water and used for the production of appertized natural apple wedges, according to the known art.

### EXAMPLE 5

Just as example 4, with the sole difference being that the 0.8% citric acid solution contained 200 ppm potassium metabisulphite.

### EXAMPLE 6

Just as example 4, with the difference being that the apples, after peeling and coring, have been sliced perpendicularly across the longest axis of the fruit to give slices 12 mm thick. The citric acid solution, containing ascorbic acid and calcium chloride, has been maintained at 60° C., and the immersion time has been 5 minutes. Following removal, the slices, rapidly drained and rinsed in tap water, have been used to make dried apple slices, according to the known art.

### EXAMPLE 7

25 kg of carrots, with a diameter of approx. 25 mm, and free from any blemishes, have been subjected to peeling using caustic soda. The concentration of caustic soda in the solution was 10%, and the carrots remained immersed for 1.5 minutes. Once removed from the solution, they have been passed under a water spray, over a series of lightly abrasive rollers, and then immersed in a 0.8% citric acid solution for several minutes. Slices, 3 mm thick have been produced using suitable known equipment. The slices, held in perforated containers, have been immersed for 5 minutes in a solution of 0.5% citric acid, containing 0.7 g/L calcium chloride, and kept shaking gently at a temperature of 80° C. The ratio of weight of carrot to solution was 0.4. Once removed, the slices of carrot have been quickly rinsed in tap water and used for the production of appertized natural carrot, according to the known art.

### EXAMPLE 8

Just as example 7, with the difference being that the citric acid solution was maintained at room temperature, and that immersion has been continued for 16 hours.

### EXAMPLE 9

25 kg of red-flesh, square-shaped sweet peppers have been cored according to the known art and cut into quarters. Equipment known in the art has been used to make slices with a nominal width of 5 mm. The slices, held in suitable perforated containers, have been immersed in a 0.6% solution of citric acid at 20° C. for 24 h. The ratio of slices to solution was equal to 0.7. Once removed, the slices have been immersed in a solution of 1 g/L CaCl₂ at room temperature, and kept in said solution for 1 hour. Once removed, drained and quickly rinsed in tap water, the sweet pepper slices have been used to make sweet pickled sweet-peppers, according to the known art.

### EXAMPLE 10

10 kg of celery stalks, after thorough washing in water, have been sliced to give 5 mm slices using equipment known in the art, and, held in suitable perforated containers, immersed in a solution of 0.5% citric acid, containing 0.1% ascorbic acid, maintained at 85° C. The ratio of celery to solution was equal to 1.0. Immersion has been continued for 6 minutes, after which the slices have been removed, drained by centrifugation in a basket and used for drying in a tunnel, according to the known art.

### EXAMPLE 11

50 kg of plumb tomatoes, with a length to diameter ratio greater than 1.3, perfectly ripened over all surfaces, with poorly developed seed cavities and free from any defects, have been trimmed, using equipment known in the art, to remove both ends and subsequently, by means of other equipment known in the art, slices, with a nominal thickness of 8 mm, have been made perpendicular to the major axis of the fruit. After draining, in order to eliminate water and the seeds from the seed cavities, the slices have been immersed in a 0.6% solution of citric acid containing 0.12% ascorbic acid, at room temperature, and kept in said solution for 16 hours. Once removed and thoroughly drained, the slices have been used for drying in a tunnel drier, according to the prior art, for the production of dried tomato flakes.

### EXAMPLE 12

5 kg of tomatoes with the same characteristics as those of example 11, have been subjected to peeling using caustic soda. Inside suitable containers, the tomatoes have been immersed for 4 minutes in an 8% solution of caustic soda, maintained at a temperature of 80° C. Once the containers holding the tomatoes have been removed, they have been immersed in tap water, in order to help with the manual removal of any remaining parts of skin that have not been perfectly detached. After this, the peeled tomatoes have been manually cut longitudinally in two halves, the liquid and seeds drained from the seed cavities, and the halves immersed for 15 minutes in a 0.5% solution of citric acid, containing 0.1% ascorbic acid and 0.5 g/L calcium chloride, kept with gentle agitation at a temperature of 50° C. The ratio of tomato to solution was equal to 0.25. Once removed from the solution and drained, they have then been dried in order to make IMF, according to the known art.

1. A process for the production of hypoallergenic derivatives of fruit and/or vegetable pieces, comprising the stages of:
a) peeling the products, if required;
b) optionally reducing the sizes of the products;
c) performing a step to remove allergens, including those responsible for OAS (oral allergy-syndrome), using an acid solution.

2. The process according to claim 1 wherein the products are peeled chemically.

3. The process according to claim 1 wherein the peeling of the products is carried out using a solution of caustic soda (sodium hydroxide).

4. The process according to claim 1 wherein the solution of caustic soda has a concentration comprised of between 1 and 20%, preferably between 3 and 10%.

5. The process according to claim I wherein the solution of caustic soda is used at a temperature comprised of between 5 and 100° C., preferably between 30 and 85%.

6. The process according to claim 1 wherein the pieces of fruit or vegetables are kept immersed in the solution of caustic soda for periods of time comprised of between 30 seconds and 20 minutes, preferably between 1 and 10 minutes.

7. The process according to claim 1 wherein, to the caustic soda are added surfactants permitted for food use.

8. The process according to claim 1 comprising, between step a) and step b) , a step al) of washing the fruit and/or vegetables with running water and subsequently with acidified water containing an organic or mineral acid.

9. The process according to claim 8 wherein said acid is citric acid in concentrations comprised of between 0.1 and 3%, preferably 0.5 and 2.0%.

10. The process according to claim 1 wherein the products are peeled mechanically.

11. The process according to claim 1 wherein, in step b) , the fruit and vegetables are cut into pieces.

12. The process according to claim 11 wherein the pieces can be fruit halves, cubes, slices, segments, sticks, strings or other shapes.

13. The process according to claim 1 wherein, in step c), the fruit and vegetables are immersed in an acid solution.

14. The process according to claim 1 wherein the acid solution contains organic or mineral acids.

15. The process according to claim 1 wherein, in step c), the acid solution contains citric acid.

16. The process according to claim 1 wherein, in step c), the acid solution has a concentration comprised of between 0.1 and 10%, preferably between 0.5 and 5%.

17. The process according to claim 1 wherein the temperature of the acid solution in step c) is comprised of between 5 and 100° C., preferably between 5 and 40° C. or between 50 and 90° C.

18. The process according to claim 1 wherein the immersion time of the fruit and/or vegetables in the acid solution is comprised of between 1 minute and 24 hours, preferably between 2 and 30 minutes, or between 5 and 20 hours.

19. The process according to claim 1 wherein the acid solution of step c) comprises antioxidants permitted for food use.

20. The process according to claim 19 wherein said antioxidant is ascorbic acid.

21. The process according to claim 20 wherein the quantity of ascorbic acid is comprised of between 0.3 and 1.5%.

22. The process according to claim 19 wherein said antioxidant is sulphurous anhydride.

23. The process according to claim 22 wherein the sulphurous anhydride is added as, potassium metabisulphite.

24. The process according to claim 22 wherein the quantity of metabisulphite added to the acid solution is comprised of between 50 and 300 mg/L, expressed as sulphurous anhydride.

25. The process according to claim 1 wherein, to the acid solution of step c), containing antioxidants or not, is added calcium chloride in concentrations comprised of between 0.3 and 2.0 g/L, preferably between 0.5 and 1.2 g/L.

26. The process according to claim 1 wherein the ratio between fruit/vegetable and acid solution is comprised of between 0.1 and 1.0, preferably between 0.4 and 0.8 (w:v).

27. The process according to claim 1 wherein, after step c1), the fruit/vegetable is subjected to at least one wash step c1), under the same conditions as step a1).

28. The process according to claim 27 wherein said wash (step c1) is performed in continuous mode.

29. The process according to claim 1 wherein prior to step a) said fruit and/or vegetables are subjected to the operations of washing, sorting and peeling.

30. The process according to claim 1 wherein the product obtained is a hypoallergenic semifinished product which is subsequently transformed into: appertized fruit in syrup, appertized natural fruit, appertized natural vegetables, candied fruit or vegetables, dried fruit or vegetables, Intermediate Moisture Food (IMF) fruit or vegetables, freshly frozen fruit or vegetables, pickled or sweet pickled vegetables.

31. The process according to claim 1 wherein said fruit and/or vegetables are selected from: tomato (Lycopersicon esculentum), carrot (Daucus carota), string bean (Faseolus vulgaris), pea (Pisum sativus), celery (Apium graveolens) , celeriac (Apium graveolens rapaceum), sweet pepper (Capsicum annuum), cucumber (Cucumis sativa), egg plant (Solanum melongena), squash and courgette (CucurJbifca spp), cabbage (Brassica spp.) , onion (Allium coepa) , fennel (Foeniculum vulgare), peach (Prunus persica) , apricot (Prunus armeniaca) , apple (Malus communis), pear (Pyrus communis) , cherry and black-cherry (Prunus avium and Prunus cerasus), kiwi (Actinidia chinensis, Actinidia deliciosa), melon (Cucumis melo), pineapple (Ananas spp.), banana (Musa spp.), grape (Vitis spp.).

32. A product available by means of the process according claim 1.

33. A fruit and/or vegetable based product obtained from fruit and/or vegetables treated according to the process according to claim 1.

34. The product according to claim 33 wherein said product is: appertized fruit in syrup, appertized natural fruit, appertized natural vegetables, candied fruit or vegetables, dried fruit or vegetables, Intermediate Moisture Food (IMF) fruit or vegetables, freshly frozen fruit or vegetables, pickled or sweet pickled vegetables.
